(19) United States
(12) Patent Application Publication
(10) Pub. No.: US 2023/0333242 A1
(43) Pub. Date: Oct. 19, 2023

(54) COLLABORATIVE ENVIRONMENT SENSING IN WIRELESS NETWORKS

(71) Applicant: HUAWEI TECHNOLOGIES CO., LTD., SHENZHEN (CN)

(72) Inventors: NAVID TADAYON, Kanata (CA); ALIREZA BAYESTEH, Kanata (CA); JIANGLEI MA, Kanata (CA); WEN TONG, Kanata (CA)

(21) Appl. No.: 18/337,199

(22) Filed: Jun. 19, 2023

Related U.S. Application Data
(63) Continuation of application No. PCT/CN2020/138879, filed on Dec. 24, 2020.

(51) Int. Cl. G01S 13/87; G01S 7/00

(52) U.S. Cl. CPC G01S 13/878; G01S 7/006

(57) ABSTRACT

Some embodiments of the present disclosure provide a manner for sensing devices (UEs) to collaborate with base stations to sense an environment. The UEs may obtain observations based on sensing signals transmitted in the environment and provide the observations to a dedicated processing node. The processing node is configured to process the received observations to coherently combine the observations to generate an enhanced observation. In addition to distributing the sensing to multiple UEs, the processing of the observations may also be distributed.

### CROSS-REFERENCE TO RELATED APPLICATIONS

This application is a continuation of International Application No. PCT/CN2020/138879, entitled “COLLABORATIVE ENVIRONMENT SENSING IN WIRELESS NETWORKS” and filed on Dec. 24, 2020, the disclosure of which is hereby incorporated by reference in its entirety.

### TECHNICAL FIELD

The present disclosure relates generally to environment sensing in wireless networks and, in particular embodiments, to collaborative environment sensing.

### BACKGROUND

In a sensing-enabled communication network, a transmission point (TP) sends sensing signals to obtain information about an environment in which operates a user equipment (UE) that communicates with the TP.

The sensing signals may, in one example, be RADAR (Radio Azimuth Direction and Ranging) signals. The term RADAR need not always be expressed in all caps; “RADAR, Radar” and “radar” are equally valid. Radar is typically used for detecting a presence and a location of an object. A system using one type of radar, called “pulsed radar,” radiates a pulse of energy and receives echoes of the pulse from one or more targets. The system determines the pose of a given target based on the echoes returned from the given target. A system using another type of radar, called “pulse-compression radar,” uses the same amount of energy as is used in the pulsed radar system. However, in the pulse-compression radar system, the energy is spread in time and in frequency to reduce the instantaneous radiated power.

Environment sensing using radar signals has a very long history, particularly in military applications. Recently, the application of sensing using radar signals has been extended to vehicular applications for adaptive cruise control, collision avoidance and lane change assistance.

Another type of sensing signal is used in LIDAR (Light Detection and Ranging). Recently, advances in self-driving cars have relied on LIDAR technology to allow cars to sense the environment in which the cars are expected to navigate safely.

Elements of a given network may benefit from exploiting information regarding the position, the behavior, the mobility pattern, etc., of the UE in the context of a priori information describing a wireless environment in which the UE is operating. However, building a radio frequency map of the wireless environment using radar may be shown to be a highly challenging and open problem. The difficulty of the problem may be considered to be due to factors such as the limited resolution of sensing elements, the dynamicity of the environment and the huge number of objects whose electromagnetic properties and position are to be estimated.

### SUMMARY

Some embodiments of the present disclosure provide a manner for sensing devices (UEs) to collaborate with base stations to sense an environment. Sensing an environment may, for example, involve resolving details of an object in a three-dimensional (3D) space. The UEs may obtain observations based on sensing signals transmitted in the environment and provide the observations to a dedicated processing node. The processing node is configured to process the received observations to coherently combine the observations to generate an enhanced observation. In addition to distributing the sensing to multiple UEs, the processing of the observations may also be distributed.

Resolving details of an object in a 3D space involves coherent combining of observations from distinct devices in different domains. Co-phasing of the transmissions from multiple devices, to achieve the constructive super-position of sensing signals at a given location, has potential to achieve both range resolution and cross-range resolution. Conveniently, collaborative sensing can be seen as a manner for reducing sensing overhead and/or increasing sensing precision.

According to an aspect of the present disclosure, there is provided a method. The method includes receiving, by a user equipment (UE), timing information for a sensing signal, receiving, by the UE and based on the timing information, a reflection of the sensing signal as part of carrying out an environment sensing operation and transmitting, to a processing node, an indication of the received reflection.

According to another aspect of the present disclosure, there is provided a method. The method includes obtaining, by a processing node, information about transmission resources for a plurality of observations associated with a respective plurality of user equipments (UEs), receiving, by the processing node, the plurality of observations from the respective plurality of UEs according to the obtained information about the transmission resources and processing the received plurality of observations for generating an enhanced observation.

According to a further aspect of the present disclosure, there is provided a method. The method includes receiving reflections of radio frequency signals as part of carrying out an environment sensing operation, receiving, from a plurality of sensing devices, a corresponding plurality of remote observations, each remote observations, among the plurality of remote observations, associated with a respective sensing device location and a respective sensing device orientation and transmitting an enhanced observation obtained by integrating a local observation, obtained by processing the received reflections, with the plurality of remote observations.

According to a still further aspect of the present disclosure, there is provided a method. The method includes receiving a plurality of sensing-specific synchronization information associated with a corresponding plurality of sensing devices, receiving a plurality of sensing-specific positioning information associated with the plurality of sensing devices, receiving reflections of radio frequency signals as part of carrying out an environment sensing operation, receiving, from the plurality of sensing devices, a corresponding plurality of remote observations and transmitting a collaborative observation obtained by integrating a local observation, obtained by processing the received reflections, with the plurality of remote observations.

According to an even further aspect of the present disclosure, there is provided a method. The method includes receiving reflections of radio frequency signals as part of carrying out an environment sensing operation, receiving, from a sensing device, a partial inferential message including a partial inferential outcome obtained by processing a plurality of observations and transmitting an enhanced observation obtained by integrating a local observation, obtained by processing the received reflections, with the partial inferential outcome.

According to an even still further aspect of the present disclosure, there is provided a method. The method includes receiving reflections of radio frequency signals as part of carrying out an environment sensing operation, receiving, from a plurality of sensing devices, a corresponding plurality of remote observations and transmitting a partial inferential message including a partial inferential outcome obtained by integrating a local observation, obtained by processing the received reflections, with the plurality of remote observations.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates a simplified schematic diagram of a communication system in which embodiments of the disclosure may occur, the communication system includes an example user equipment and an example base station;

FIG. 2 illustrates, as a block diagram, the example user equipment of FIG. 1, according to aspects of the present disclosure;

FIG. 3 illustrates, as a block diagram, the example base station of FIG. 1, according to aspects of the present disclosure;

FIG. 4 illustrates multiple physical user equipments casting a respective sensing beam towards a portion of a target, according to aspects of the present disclosure;

FIG. 5 illustrates example steps in a method of carrying out sensing, as part of a collaborative sensing effort, from the perspective of a single user equipment, according to aspects of the present disclosure;

FIG. 6 illustrates example steps in a method, carried out at a base station, of configuring collaborative sensing by a plurality of sensing devices, according to aspects of the present disclosure;

FIG. 7 illustrates example steps in a method of carrying out sensing, as part of a collaborative sensing effort, from the perspective of a base station, according to aspects of the present disclosure;

FIG. 8 illustrates, in a flow diagram, interaction between a user equipment and a base station as the user equipment obtains observations, according to aspects of the present disclosure;

FIG. 9 illustrates, in a flow diagram as an alternative to the flow diagram of FIG. 8, interaction between a user equipment and a base station as the user equipment obtains observations, according to aspects of the present disclosure;

FIG. 10 illustrates example steps in a method, carried out at a base station 170, of configuring collaborative sensing by a plurality of user equipment, according to aspects of the present disclosure;

FIG. 11 illustrates an example network scenario wherein three base stations and four user equipments collaborate in sensing an object, according to aspects of the present disclosure;

FIG. 12 illustrates an example sensing graph for the sensing scenario in FIG. 11, according to aspects of the present disclosure;

FIG. 13 illustrates an example transmission graph for the sensing scenario in FIG. 11, according to aspects of the present disclosure;

FIG. 14 illustrates an example processing graph 1400 for the sensing scenario in FIG. 11, according to aspects of the present disclosure;

FIG. 15 illustrates an example network scenario wherein three base stations and three user equipments collaborate in sensing an object, according to aspects of the present disclosure; and

FIG. 16 illustrates an example expansion of an equation to illustrate individual matrix elements.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

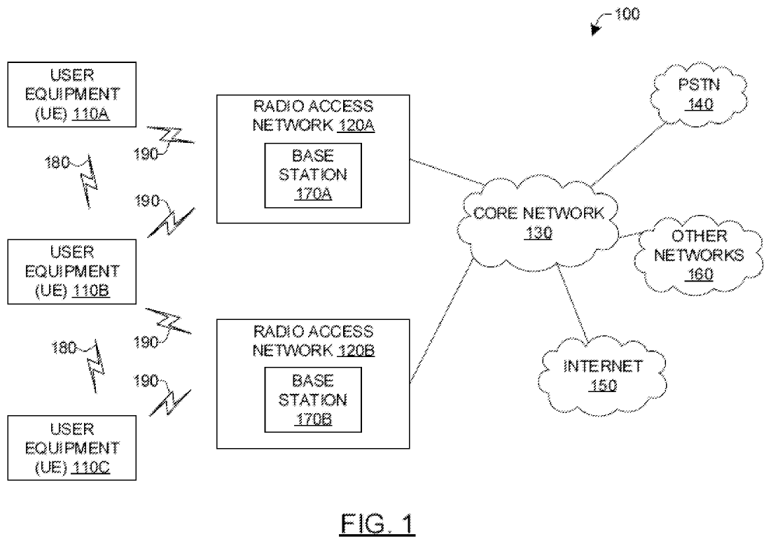

FIG. 1 illustrates, in a schematic diagram, an example communication system 100. In general, the communication system 100 enables multiple wireless or wired elements to communicate data and other content. The purpose of the communication system 100 may be to provide content (voice, data, video, text) via broadcast, narrowcast, user device to user device, etc. The communication system 100 may operate efficiently by sharing resources, such as bandwidth.

In this example, the communication system 100 includes a first user equipment (UE) 110A, a second UE 110B and a third UE 110C (individually or collectively 110), a first radio access network (RAN) 120A and a second RAN 120B (individually or collectively 120), a core network 130, a public switched telephone network (PSTN) 140, the Internet 150 and other networks 160. Although certain numbers of these components or elements are shown in FIG. 1, any reasonable number of these components or elements may be included in the communication system 100.

The UEs 110 are configured to operate, communicate, or both, in the communication system 100. For example, the UEs 110 are configured to transmit, receive, or both via wireless communication channels. Each UE 110 represents any suitable end user device for wireless operation and may include such devices (or may be referred to) as a wireless transmit/receive unit (WTRU), a mobile station, a mobile subscriber unit, a cellular telephone, a station (STA), a machine-type communication device (MTC), an Internet of Things (IoT) device, a personal digital assistant (PDA), a smartphone, a laptop, a computer, a touchpad, a wireless sensor or a consumer electronics device.

In FIG. 1, the first RAN 120A includes a first base station 170A and the second RAN includes a second base station 170B (individually or collectively 170). The base station 170 may also be called an anchor or a transmit point (TP). Each base station 170 is configured to wirelessly interface with one or more of the UEs 110 to enable access to any other base station 170, the core network 130, the PSTN 140, the internet 150 and/or the other networks 160. For example, the base stations 170 may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP) or a wireless router. Any UE 110 may alternatively or additionally be configured to interface, access or communicate with any other base station 170, the internet 150, the core network 130, the PSTN 140, the other networks 160 or any combination of the preceding. The communication system 100 may include RANs, such as the RAN 120B, wherein the corresponding base station 170B accesses the core network 130 via the internet 150, as shown.

The UEs 110 and the base stations 170 are examples of communication equipment that can be configured to implement some or all of the functionality and/or embodiments described herein. In the embodiment shown in FIG. 1, the first base station 170A forms part of the first RAN 120A, which may include other base stations (not shown), base station controller(s) (BSC, not shown), radio network controller(s) (RNC, not shown), relay nodes (not shown), elements (not shown) and/or devices (not shown). Any base station 170 may be a single element, as shown, or multiple elements, distributed in the corresponding RAN 120, or otherwise. Also, the second base station 170B forms part of the second RAN 120B, which may include other base stations, elements and/or devices. Each base station 170 transmits and/or receives wireless signals within a particular geographic region or area, sometimes referred to as a “cell” or “coverage area.” A cell may be further divided into cell sectors and a base station 170 may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RANs 120 shown is exemplary only. Any number of RANs may be contemplated when devising the communication system 100.

The base stations 170 communicate with one or more of the UEs 110 over one or more air interfaces 190 using wireless communication links, e.g., radio frequency (RF) wireless communication links, microwave wireless communication links, infrared (IR) wireless communication links, visible light (VL) communications links, etc. The air interfaces 190 may utilize any suitable radio access technology. For example, the communication system 100 may implement one or more orthogonal or non-orthogonal channel access methods, such as code division multiple access (CDMA), time division multiple access (TDMA), frequency division multiple access (FDMA), space division multiple access (SDMA), orthogonal FDMA (OFDMA) or single-carrier FDMA (SC-FDMA) in the air interfaces 190.

A base station 170 may implement Universal Mobile Telecommunication System (UMTS) Terrestrial Radio Access (UTRA) to establish the air interface 190 using wideband CDMA (WCDMA). In doing so, the base station 170 may implement protocols such as High Speed Packet Access (HSPA), Evolved HPSA (HSPA+) optionally including High Speed Downlink Packet Access (HSDPA), High Speed Packet Uplink Access (HSUPA) or both. Alternatively, a base station 170 may establish the air interface 190 with Evolved UTMS Terrestrial Radio Access (E-UTRA) using LTE, LTE-A, LTE-B and/or 5G New Radio (NR). It is contemplated that the communication system 100 may use multiple channel access functionality, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE and GERAN. Of course, other multiple access schemes and wireless protocols may be utilized.

The RANs 120 are in communication with the core network 130 to provide the UEs 110 with various services such as voice communication services, data communication services and other communication services. The RANs 120 and/or the core network 130 may be in direct or indirect communication with one or more other RANs (not shown), which may or may not be directly served by the core network 130 and may or may not employ the same radio access technology as the first RAN 120A, the second RAN 120B or both. The core network 130 may also serve as a gateway access between (i) the RANs 120 or the UEs 110 or both, and (ii) other networks (such as the PSTN 140, the Internet 150 and the other networks 160).

The UEs 110 may communicate with one another over one or more sidelink (SL) air interfaces 180 using wireless communication links, e.g., radio frequency (RF) wireless communication links, microwave wireless communication links, infrared (IR) wireless communication links, visible light (VL) communications links, etc. The SL air interfaces 180 may utilize any suitable radio access technology and may be substantially similar to the air interfaces 190 over which the UEs 110 communicate with one or more of the base stations 170 or they may be substantially different. For example, the communication system 100 may implement one or more channel access methods, such as CDMA, TDMA, FDMA, SDMA, OFDMA or SC-FDMA in the SL air interfaces 180. In some embodiments, the SL air interfaces 180 may be, at least in part, implemented over unlicensed spectrum.

Some or all of the UEs 110 may include functionality for communicating with different wireless networks over different wireless links using different wireless technologies and/or protocols. Instead of wireless communication (or in addition thereto), the UEs 110 may communicate via wired communication channels to a service provider or a switch (not shown) and to the Internet 150. The PSTN 140 may include circuit switched telephone networks for providing plain old telephone service (POTS). The Internet 150 may include a network of computers and subnets (intranets) or both and incorporate protocols, such as internet protocol (IP), transmission control protocol (TCP) and user datagram protocol (UDP). The UEs 110 may be multimode devices capable of operation according to multiple radio access technologies and incorporate multiple transceivers necessary to support multiple radio access technologies.

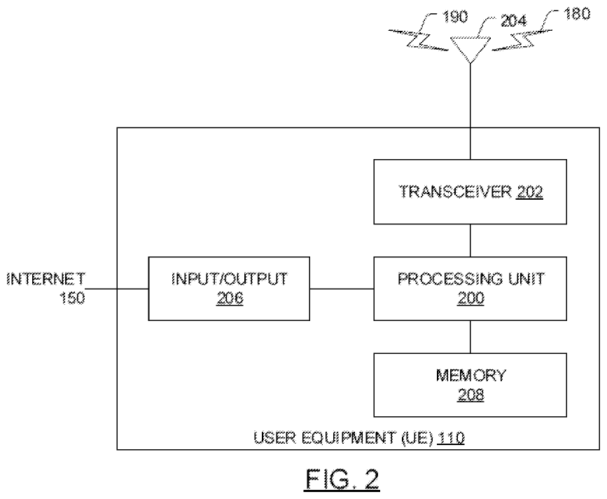

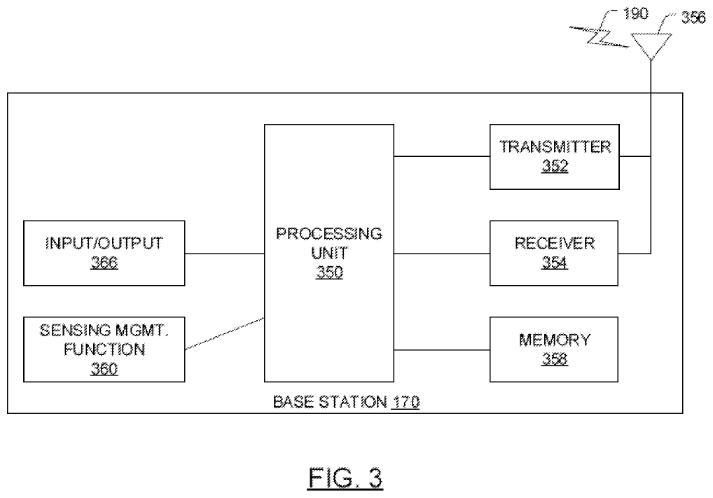

FIGS. 2 and 3 illustrate example devices that may implement the methods and teachings according to this disclosure. In particular, FIG. 2 illustrates an example UE 110 and FIG. 3 illustrates an example base station 170. These components could be used in the communication system 100 of FIG. 1 or in any other suitable system.

As shown in FIG. 2, the UE 110 includes at least one UE processing unit 200. The UE processing unit 200 implements various processing operations of the UE 110. For example, the UE processing unit 200 could perform signal coding, data processing, power control, input/output processing, or any other functionality enabling the UE 110 to operate in the communication system 100. The UE processing unit 200 may also be configured to implement some or all of the functionality and/or embodiments described in more detail above. Each UE processing unit 200 includes any suitable processing or computing device configured to perform one or more operations. Each UE processing unit 200 could, for example, include a microprocessor, microcontroller, digital signal processor, field programmable gate array, or application specific integrated circuit.

The UE 110 also includes at least one transceiver 202. The transceiver 202 is configured to modulate data or other content for transmission by at least one antenna or Network Interface Controller (NIC) 204. The transceiver 202 is also configured to demodulate data or other content received by the at least one antenna 204. Each transceiver 202 includes any suitable structure for generating signals for wireless or wired transmission and/or processing signals received wirelessly or by wire. Each antenna 204 includes any suitable structure for transmitting and/or receiving wireless or wired signals. One or multiple transceivers 202 could be used in the UE 110. One or multiple antennas 204 could be used in the ED 110. Although shown as a single functional unit, a transceiver 202 could also be implemented using at least one transmitter and at least one separate receiver.

The UE 110 further includes one or more input/output devices 206 or interfaces (such as a wired interface to the Internet 150). The input/output devices 206 permit interaction with a user or other devices in the network. Each input/output device 206 includes any suitable structure for providing information to or receiving information from a user, such as a speaker, microphone, keypad, keyboard, display, or touch screen, including network interface communications.

FIG. 3 further illustrates an optional component of the BS 170, that is, a sensing management function 360 configured for carrying out aspects of the present application. The sensing management function 360 may be implemented in hardware or implemented as a software module that is executed by the BS processing unit 350.

In addition, the UE 110 includes at least one UE memory 208. The UE memory 208 stores instructions and data used, generated, or collected by the ED 110. For example, the UE memory 208 could store software instructions or modules configured to implement some or all of the functionality and/or embodiments described above and that are executed by the UE processing unit(s) 200. Each UE memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 3, the base station 170 includes at least one BS processing unit 350, at least one transmitter 352, at least one receiver 354, one or more antennas 356, at least one memory 358, and one or more input/output devices or interfaces 366. A transceiver, not shown, may be used instead of the transmitter 352 and receiver 354. The BS processing unit 350 implements various processing operations of the base station 170, such as signal coding, data processing, power control, input/output processing, or any other functionality. The BS processing unit 350 can also be configured to implement some or all of the functionality and/or embodiments described in more detail above. Each BS processing unit 350 includes any suitable processing or computing device configured to perform one or more operations. Each BS processing unit 350 could, for example, include a microprocessor, microcontroller, digital signal processor, field programmable gate array, or application specific integrated circuit.

Each transmitter 352 includes any suitable structure for generating signals for wireless or wired transmission to one or more UEs or other devices. Each receiver 354 includes any suitable structure for processing signals received wirelessly or by wire from one or more UEs or other devices. Although shown as separate components, at least one transmitter 352 and at least one receiver 354 could be combined into a transceiver. Each antenna 356 includes any suitable structure for transmitting and/or receiving wireless or wired signals. Although a common antenna 356 is shown here as being coupled to both the transmitter 352 and the receiver 354, one or more antennas 356 could be coupled to the transmitter(s) 352, and one or more separate antennas 356 could be coupled to the receiver(s) 354. Each memory 358 includes any suitable volatile and/or non-volatile storage and retrieval device(s) such as those described above in connection to the UE 110. The memory 358 stores instructions and data used, generated, or collected by the base station 170. For example, the memory 358 could store software instructions or modules configured to implement some or all of the functionality and/or embodiments described above and that are executed by the BS processing unit(s) 350.

Each input/output device 366 permits interaction with a user or other devices in the network. Each input/output device 366 includes any suitable structure for providing information to or receiving/providing information from a user, including network interface communications.

A sensing operation performed on an environment may be considered to be an operation of gaining cognition about the environment. This cognition can relate to location, texture or dimensions of significant static objects in the environment or some other information on the mobility pattern in the environment. This definition of sensing has some roots into the old field of RADAR. In the context of environment sensing, radar may be used to perform reconnaissance on the environment through, first, transmission of radio frequency waves from, often, stationary platforms and, second, processing of returned echoes of the transmitted radio frequency waves.

After several decades of development, radar is now a fully developed technology with mature theoretical foundations and a proven record. Radar equipment is used in airborne, space-borne and terrestrial settings for a diverse range of remote sensing applications. Such remote sensing applications vary from search and surveillance through earth surface imaging to environmental monitoring. All of these remote sensing applications have one thing in common; these remote sensing applications all use a highly tuned and expensive system with ultra-accurate and stable sensors equipped with extreme processing and communications capabilities, having a precise knowledge of its position and the global time which is to be frequently calibrated and monitored. In addition to this, there are other unwavering conditions for successful operation of traditional radar systems: (i) to have an unobstructed view of the environment to be sensed; and (ii) to reject, as much as possible, reflections from unintended clutter in the environment. Both these conditions tend to restrict the successful application of radars to non-terrestrial applications, where either a terrestrial radar is gazing up to the sky/space to sense a few cruising/clustered objects or an airborne radar is gazing down to the earth to detect activities on the earth's surface.

Radar technology is expected to play an important role in future cellular networks, with each transmitter, each receiver and each of many targets (also known as “objects” and “clutter”) being located on the earth at very low “elevation angles.” The benefits of conducting wireless environment sensing are known to be abundant. Indeed, it is known that accurate sensing of a wireless environment can lead to improvements in different aspects of the communications systems that operate in the wireless environment. Such aspects include: bandwidth efficiency; power efficiency; agility; enhanced coverage; reduced delay; etc. These improvements may be seen to be derived from the manner in which the knowledge of the wireless environment, obtained by accurate environment sensing, tends to shift communications practice from a reactive methodology to a proactive methodology. In the proactive methodology, decisions to be made by the network are, beneficially, made “medium-aware.”

With a goal of a proactive methodology and the resultant terrestrial medium-awareness, a problem may be stated as “How shall components of a terrestrial network achieve sufficiently accurate environment sensing?” Whereas it might seem straightforward to achieve sufficiently accurate environment sensing by network-side sensing, that is, incorporating radar equipment into network infrastructure, it may be shown that there are intricacies to solving this problem. Note that the network infrastructure may be understood to take the form of a transmit/receive point, often shortened to “TRP.” More specifically, such network-side sensing is severely hampered by the fact that the view to some clutter (background objects) is often obstructed by some other clutter (foreground objects). This problem happens due to the undesired geometry of sensing in terrestrial settings where, from the vantage point of transmitter/receiver (i.e., the TRP) of the sensing signal, abundant targets are dispersed in a three-dimensional (3D) space. The ramification of such topology is two-fold: (i) sometimes the network-side sensing system may be unable to detect and estimate the properties (e.g., location) of a particular target in the background; (ii) other times, the network-side sensing system may detect the presence of background objects but incorrectly estimate properties of the background objects due to multi-bounce reflection between the foreground objects and background objects.

Another challenge with the network-side sensing is a so-called escaping beam problem. The escaping beam problem occurs when sensing is performed at radio frequencies where the specular reflection is the dominant propagation mechanism. In specular reflection, the incident signal is reflected in a single direction. Typically, for specular reflection, the angle of incidence equals the angle of reflection. That is, the direction of a beam reflected from a target depends solely on the angle of incidence and the orientation of the exposed surface of that target.

The term “mono-static sensing” is used to represent sensing wherein the transmitter of the sensing signal and the receiver of reflections of the sensing signal are collocated. When mono-static sensing is used in the presence of specular reflection, the receiver may be shown to be able to detect a target when the transmitted signal and the signal reflected by the target traverse the same path. More broadly, the receiver may be shown to be able to detect a target when the transmitted signal and the signal reflected by the target fall within a sensing beamwidth. With sensing beams intentionally sharpened to avoid reception of reflections and noise from unintended clutter, the likelihood of the transmitted signal and the signal reflected by the target falling within a sensing beamwidth can become quite slim.

The escaping beam problem may be shown to be exacerbated by the low number of sensing TRPs in the network. The escaping beam problem may also be shown to be exacerbated by the target and the TRP being immobile with respect to each other. An argument may be made that, for those situations in which there are many TRPs covering a given field of view with a narrow transmit beam and a narrow receive beam, the escaping beam problem is less and less of an issue. Also, when the sensing TRP is a mobile platform, there is high chance that, somewhere along the trajectory, its beam broadside becomes “normal” to the reflecting surface of the target, which increases the chance that the mobile TRP will receive a reflected signal.

It may be shown that increasing the frequency of the transmitted sensing signal comes with many advantages. For example, sensing may be performed using a sensing signal with a frequency in the Terahertz range. Using frequencies in the Terahertz range, the reflections of the sensing signal may be shown to defuse, or scatter. This means that, no matter from which direction a target receives a sensing signal, the reflections scatter in a wide variety of directions. Accordingly, at least some of the reflections will eventually be received at the sensing receiver. Nonetheless, the problem with sensing at higher frequencies is the severe path loss and attenuation. The latter can be a significant hindrance for network-side sensing, as the target is often far from the sensing TRPs. Accordingly, while network-side sensing might appear, at first glance, to be a practical approach, in reality, the network-side sensing approach is hampered by enough factors to render the approach ineffective.

By delegating, to UEs, performance of the sensing, the abovementioned foreground/background problem can be obviated. This is due to futuristic UEs being mobile entities with moderate sensing capabilities that are dispersed in the field of sensing. These UEs are expected to be abundant and at least some UEs are expected to be in proximity to the targets to be sensed. As such, there is, generally, a reasonable prospect that a target situated in the background from the vantage point of a given TRP is situated in the foreground of one or more UEs.

The mobility of the UEs may be considered both a curse and a blessing. Whereas the blessing is found through the capture of observations of a sensing scene from diverse perspectives, the curse is found in a lack of precise knowledge of details of the UEs. Such details include UE locations and UE timing. Furthermore, UEs may be understood to have sensing capabilities that are inferior to the static TRPs in the network, thereby allowing for new sources of sensing error relative to sensing performed only by static TRPs.

Aspects of the present application relate to a collaborative sensing scheme. In the collaborative sensing scheme, multiple sensing devices (UEs and/or TRPs) obtain sensing observations of an object from different vantage points. The various sensing observations are coherently combined to form a single, combined observation. The combined observation may be shown to achieve a resolution better than the resolution achievable from any single sensing device.

The coherent combining of the “raw” sensing observations involves the waveforms from all the sensing devices arriving at the desired target in a co-phased manner. In other words, coherent combining involves constructive superposition of waveforms at a particular location in space. Coherent combining may also involve destructive superposition of wave-fronts in nearby spots. This process of integrating multiple low-resolution sensing observations to obtain a single high-resolution sensing observation can be cast as replacing a multiple physical sensing devices with a single (yet virtual) super sensing device with a sensing capability that is significantly improved over the sensing capabilities of any one of the individual physical sensing devices.

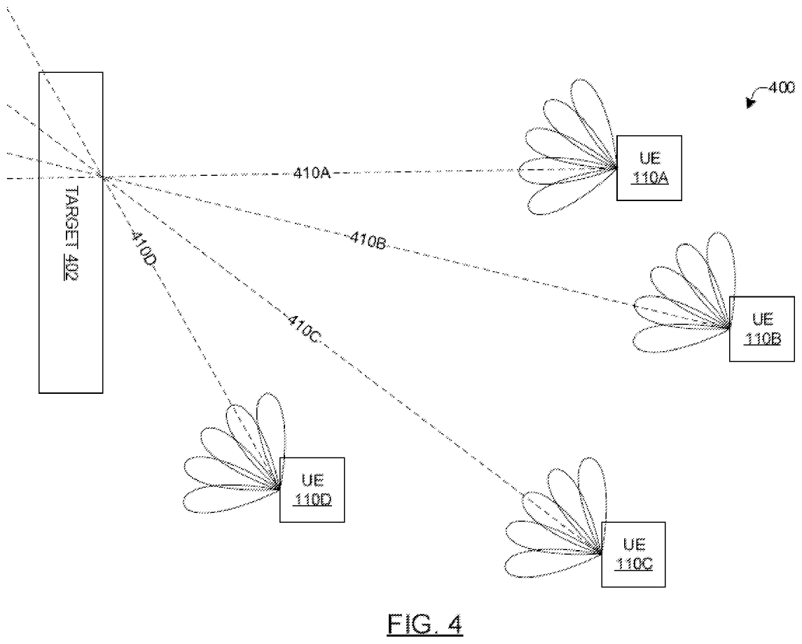

Aspects of the present application may be understood in the context of a network 400 illustrated in FIG. 4. In FIG. 4, multiple physical UEs 110A, 1106, 110C, 110D are illustrated as casting a respective sensing beam 410A, 4106, 410C, 410D (individually or collectively 410) towards a portion of a target 402. In FIG. 4, the target 402 is a building. Resolving details of an object in a 3D space involves coherent combining of raw observations from distinct sensing devices (e.g., the UEs 110) in distinct domains. Each sensing beam 410 is understood to be a product of beamforming to direct the sensing beam 410 at a specific point on the target 402.

The classic notion of transmit (or receive) beamforming is understood to involve individually adjusting phases of signals transmitted at each antenna element in an array of antenna elements such that wave-fronts in a desired direction are superposed in a constructive manner. This superposition may be achieved given a desired direction towards which the beam is to be steered and given geometry for the array of antenna elements. The latter is required so as to realize how much to delay (or to phase-shift) each antenna element to gain constructive momentum in far field. Known angle-radar systems operate on the same principle, in that an angle-radar system generates a narrow beam using an array of antennas illuminating angular segments of space. A principal difference between beamforming in radar and beamforming in communication is that the angle of arrival/departure of the wave is not known a priori in radar, a fact that necessitates the radar system to steer the beam in every direction in space.

An angle-radar system with antenna elements that are all collocated may be shown to only be capable of resolving details of an object, or capable of distinguishing between two separate objects, in the angular domain. In 3D space, where objects have volumetric dimensions, a single angle-radar system may be shown to be incapable of resolving details in a scene's depth. More specifically, the angle-radar system is only expected to be able to distinguish details in the “cross-range”domain. To be able to distinguish objects in the range domain, a range-radar is required. In a manner similar to angle-radar, a range-radar uses coherent combining of frequency components of a signal. The combination of range-radar and angle-radar may be shown to yield a system that has high resolvability in both range and cross-range domains.

When the sensing antenna elements are not collocated but, instead, are distributed in the sensing field, range and cross-range become coupled. This coupling occurs as the depth of a scene from the perspective of one sensing device has momentum along the azimuth of another sensing device and vice versa. As such, the co-phasing of the transmissions from multiple sensing devices to achieve the constructive super-position of sensing signals at a given location can potentially achieve both range and cross-range resolution. Such co-phasing involves the UEs maintaining awareness of, and accounting for, any trivial and non-trivial factors that can “affect” the phase of the sensing signal. Among factors affecting the phase of the sensing signal, important factors include: distance; antenna pattern; antenna orientation; and clock synchronization. For instance, without accounting for clock synchronization, two sensing devices that have different notions of time send waveforms that arrive at the desired spot with different phases. Likewise, not accounting for distance differences, two sensing devices at different locations send waveforms that, again, arrive at the desired spot with different phases.

In overview, aspects of the present application relate to achieving improved sensing resolution by arranging collaboration among sensing devices. As usual, the sensing devices obtain returned echoes of sensing waveforms as sensing observations. One of the sensing devices may subsequently receive sensing observations from other sensing devices along with respective sensing device location and respective sensing device orientation. The one sensing device may integrate a locally obtained sensing observation with the plurality of remotely obtained sensing observations. Through such integration, the one sensing device may obtain a collaborative sensing observation.

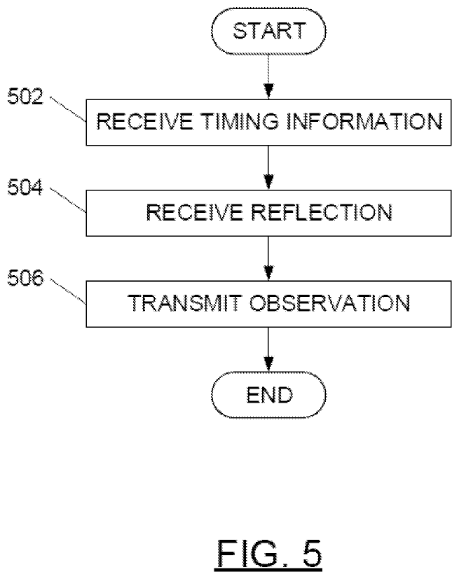

FIG. 5 illustrates example steps in a method of carrying out sensing, as part of a collaborative sensing effort, from the perspective of a single UE 110. The UE 110 receives (step 502) timing information for a sensing signal that is to be transmitted, by another device, in the future. With a priori awareness of the timing of the sensing signal, the UE 110 receives (step 504) a reflection of the sensing signal. The UE 110 then transmits (step 506), toward a processing node, an indication of the received reflection. The indication of the received reflection may be understood to be a sensing observation.

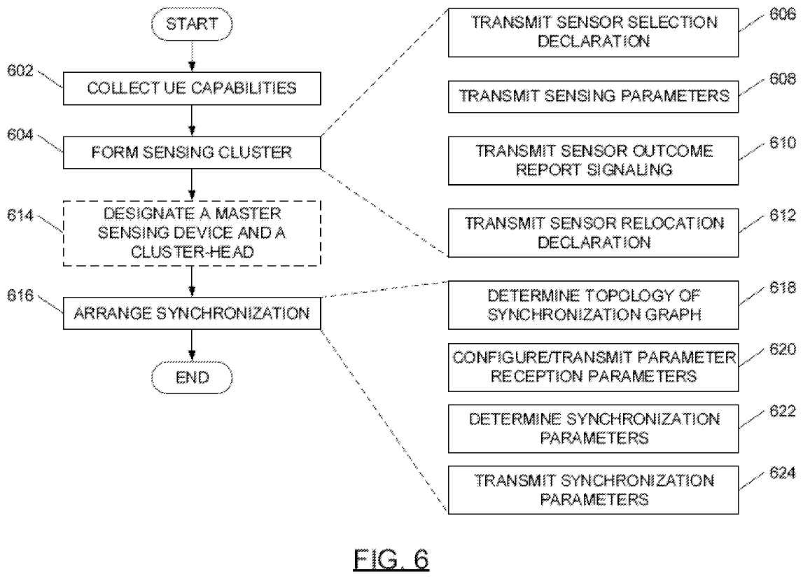

A base station 170 may be given the task of arranging and configuring the collaborative sensing. FIG. 6 illustrates example steps in a method, carried out at a base station 170, of configuring collaborative sensing by a plurality of sensing devices. It is notable that, in some aspects of the present application, all of the sensing devices are UEs 110. In other aspects of the present application, some of the sensing devices are UEs 110 and some of the sensing devices are BSs.

The BS 170 may begin the task of arranging and configuring the collaborative sensing by collecting (step 602) capability reports from the UEs 110 in a network. The BS 170 may, in one example, collect (step 602) capability reports from all of the UEs 110 in a given network. Alternatively, the BS 170 may, in another example, collect (step 602) capability reports from only a subset (a so-called “candidate” subset) of the UEs 110 in the given network.

The capability reports may, for example, include a Proximal and Locational Report (PLR). The PLR may indicate relative proximity of the UEs 110 with respect to each other or their position/attitude (orientations) in a global coordinate system (GCS). The PLR may be shown to help the network in designating specific ones of the UEs 110 to the sensing task so that the observations obtained at the designated UEs 110 have minimal redundancy/overlap.

The capability reports may, for another example, include a Sensory Capability Report (SCR). The SCR may indicate capabilities of the UEs 110. The capabilities may include: maximum transmit power; achievable angular resolution; achievable spectral resolution; achievable temporal resolution; and synchronization parameters.

The capability reports may, for another example, include an Availability and Consent Report (ACR). The ACR may indicate availabilities of the UEs 110 for participation in the sensing task. Additionally, the ACR may indicate the extent to which each UE 110 consents to participation in the sensing task.

The capability reports may, for a further example, include a Processing/Energy Capability Report (PECR). The sensing data obtained by each UE 110 can be processed to: (i) extract, from the sensing data, readily usable information; or (ii) to compress the sensing data for transmission to the processing node. An indication of the processing capabilities of the UEs 110 allows the BS 170 to assess ability of each UE 110 to perform the extraction or the compression before assigning particular UEs 110 to processing clusters. The PECR may provide the BS 170 with an indication of the processing capabilities of the UEs 110 so that the BS 170 may perform the assessment appropriately.

The capability reports may, for a still further example, include a Communication Capability Report (CCR). The sensing data collected at the UE has to be, at some point, communicated to the other UEs 110 or to the BS 170. Such communication is only possible if the UEs 110 have sufficient energy reserve for such task and are capable of transmitting with an appropriately high data-rate.

Subsequent to receiving (step 602) the capability reports, the BS 170 may take steps to form (step 604) a sensing cluster. When forming (step 604) the sensing cluster, the BS 170 may take into account the information received in the capability reports. The sensing cluster generally includes a plurality of UEs 110 to be given the task of sensing part of an environment.

The selection of particular UEs 110 to include when forming (step 604) a sensing cluster may be made based on the capability reports collected in step 602. For example, a confidence in the precision of a priori spatial information, temporal information and sensing capabilities of UEs 110 can be a significant factor in assigning some UEs 110 to the sensing cluster and excluding some other UEs 110. Notably, the forming (step 604) of the sensing cluster may not be carried out by the BS 170. Indeed, the forming (step 604) of the sensing cluster may be carried out in a distributed manner by the UEs 110.

Signaling involved in the process of forming (step 604) the sensing cluster include: Sensor Selection Declaration (SSD) signaling; Sensor Allocation Declaration (SAD) signaling; Sensor Relocation/Readjustment Declaration (SRD) signaling; and Sensing Outcome Report (SOR) signaling.

The selecting of UEs 110 to include in a sensing cluster may be carried out with the objective of illuminating a scene while minimizing redundancy. Based on UE capabilities collected in step 602 and various sensing requirements, the BS 170 or cluster-head may transmit (step 606), to certain ones of the UEs 110 and using SSD signaling, an indication that the certain ones of the UEs 110 have been selected to be given a task of sensing a scene.

The BS 170 may, in view of which of the UEs 110 have been included in the sensing cluster, configure various sensing parameters. The sensing parameters may, for example, include beam direction, frequency, time, bandwidth, waveform, and transmit power. The BS 170 may employ SAD signaling to transmit (step 608), to the UEs 110 in the sensing cluster, the sensing-specific sensing parameters.

The BS 170 may also transmit (step 610), to the UEs 110 and employing SOR signaling, an indication of resources that are to be used for reporting sensing outcomes (observations). The resources may include: beam direction; frequency; time; bandwidth; waveform; and transmit power.

According to aspects of the present application, the BS 170 may, in view of the capability reports received in step 602, instruct some UEs 110 to readjust their respective pose to improve a corresponding viewing angle of a scene. As is known, the pose of a UE 110 relates to features such as a position of the UE 110, a velocity of the UE 110 and an orientation of the UE 110. Additionally or alternatively, the BS 170 may arrange dispatch of one or more dedicated sensing units (DSUs) to a scene. A DSU may be an aerial drone (e.g., a quadcopter) configured to act as a UE 110 with a viewing angle that is distinct from the viewing angles of existing terrestrial UE 110. Without regard to the type of sensing device (terrestrial UE 110 or DSU), the BS 170 may transmit (step 612), using SRD signaling, instructions to specific sensing devices. The SRD signaling may include: an identity of a sensing device that is to relocate to a new destination; a set of coordinates for the new destination; an orientation that the sensing device is to take at the new destination; and a trajectory to take to reach the new destination.

The sensing cluster may, optionally, include a master sensing device and/or a cluster-head. The master sensing device may be designated for combining observations. The cluster-head may be designated for establishing synchronization among the sensing devices. As such, the BS 170 may, optionally, designate (step 614) one or both of a master sensing device and a cluster-head.

Several selection criteria may be used when determining which of the UEs 110 should be designated (step 614) as the master sensing device. The master sensing device may be selected as a UE 110 with processing capabilities that are greater than the other UEs 110. The master sensing device may be selected as a UE 110 with communications capabilities that are greater than the other UEs 110. The master sensing device may be selected as a UE 110 with less stringent energy constraints in the context of the other UEs 110. The master sensing device might also be a UE 110 that has a favorable geometry with respect to the other UEs 110 in the network so as to minimize the overhead of sensing data communications.

According to aspects of the present application, upon designating (step 614) a cluster-head, the BS 170 may delegate, to the cluster-head, the task of selecting UEs 110 to include in the sensing cluster. In such a case, the collecting (step 602) of capabilities and the forming (step 604) of the sensing cluster may be carried out by the cluster-head rather than by the BS 170. In this case, the UEs 110 that would have, originally, transmitted respective capability reports to a particular BS 170, may be informed, by the particular BS 170, to transmit their respective capability reports to the designated cluster-head.

It has been mentioned, hereinbefore, that having a common notion of time is an important precursor for the enhancement of resolution achievable through use of collaborative sensing.

In the method illustrated in FIG. 6, once a sensing cluster has been formed (step 604), the BS 170 arranges (step 616) synchronization with the UEs 110.

In part, the BS 170 may determine (step 618) a topology for a so-called synchronization graph. The topology may be a star topology, a tree topology, a forest topology, or the topology of the synchronization graph can be a fully-connected network topology.

The synchronization graph may be determined based on the topology of the sensing nodes in the sensing cluster with the objective of making the problem easy to solve and well-posed while minimizing the overhead estimation noise. These criteria can be accomplished by exploiting the prior knowledge into the problem.

The BS 170 may then, in view of the topology determined in step 616, configure (step 620) various parameter reception parameters. The parameter reception parameters may, for example, include a specification of time, frequency and/or waveform for the reception, by the UEs 110, of synchronization parameters. The BS 170 may employ Sensing-specific Synchronization Configuration Declaration (SSCD) signaling to transmit (step 620), to the UEs 110, the parameter reception parameters.

As part of arranging (step 616) synchronization, the BS 170 may determine (step 622) synchronization parameters in a manner detailed in the following. The BS 170 may transmit (step 624), to the UEs 110 and using Sensing-specific Synchronization Parameter Declaration (SSPD) signaling, the synchronization parameters over resources specified in the SSCD signaling.

A clock at the BS 170 may be understood to be represented by a function, T_{BS}(t)=t. A clock at a given UE 110 may be understood to be represented by a second function, T_{SD}(t)=wt+θ, where w represents a clock skew and θ represents a clock bias. A reference signal transmitted, by the BS 170, at a time t_{BS} arrives at a given UE 110 at a time t_{SD}=t_{BS}+τ_{BS-UE}, where τ_{BS-UE} is a one-way propagation delay from a given BS 170 to a given UE 110.

Arranging synchronization (step 616) may be understood to relate to the BS 170 causing an adjustment of the clocks at the UEs 110 to minimize the respective clock skew (w) and the respective clock bias (θ) at each UE 110. Since the clocks of UEs 110 in the sensing cluster are driven by distinct, free-running oscillators, clocks at different UEs 110 may be expected to have distinct clock skews and clock biases relative to the clock at the BS 170, which may be considered a “global” time for the sensing cluster. At times, when there is incentive to minimize the clock skew and clock bias relative to the global time, a sensing-specific synchronization process may be arranged (step 616). While the sensing-specific synchronization process is arranged (step 616) to handle imperfect synchronization among UEs 110 within a sensing cluster, it is assumed, in this aspect of the present application, that knowledge of sensing device poses is available.

To achieve relatively tight synchronization, the BS 170 may instruct the cluster-head to arrange (step 616) the sensing-specific synchronization among all of the UEs 110 in a sensing cluster or among a subset of the UEs 110 in the sensing cluster. Note that the cluster-head might be a UE 110 that is different from the UE 110 that is the master sensing device. Alternatively, arrangement (step 616) of sensing-specific synchronization might be triggered by the BS 170. Aspects of the present application relate to achieving relatively tight synchronization through the use of sensing-specific synchronization reference signals (RSs) different from the reference signals that are used in current cellular systems (e.g., primary synchronization signal, “PSS,” and secondary synchronization signal, “SSS”). Specifically, sensing-specific synchronization benefits from exploitation of wideband sensing-specific synchronization reference signals that are transmitted more repetitively than reference signals used in current cellular systems. The wideband sensing-specific synchronization reference signals may be shown to provide signal-to-noise (SNR) gain. Additionally, the wideband sensing-specific synchronization reference signals may be shown to be useful to assist in, intermittently and unambiguously, tracking deviations of clock parameters.

Mathematically, the problem of synchronizing multiple (say, N) UEs 110 with a global time (e.g., the time of the clock at the cluster-head or the BS 170) may be considered to involve obtaining estimates of a clock skew vector, w=[w₁, . . . , w_{N}], and a clock bias vector, θ=[θ₁, . . . , θ_{N}], where N is the number of UEs 110 in the sensing cluster. Once the estimates have been obtained, the internal clocks of each of the UEs 110 may be adjusted to minimize clock skew and adjusted to minimize clock bias. Such adjustments may be considered similar to a manual adjustment of a pendulum clock whose displayed time has fallen behind. The adjustments may be made, at each UE 110, responsive to receiving the synchronization parameters transmitted, by the BS 170, in step 624.

In operation, estimates of clock parameters (clock skew, clock bias) may be obtained responsive to the BS 170 flooding (broadcasting) wideband sensing-specific synchronization reference signals in the network.

One mathematical representation of the sensing-specific synchronization problem to be solved to determine (step 622) synchronization parameters is presented in equation (1), as follows:

$$[ {A}_{1} \vert {A}_{2} ] \cdot [ \begin{matrix}w \\ θ\end{matrix} ] = n + [ {A}_{3} \vert {A}_{4} \vert {A}_{5} ] [ \begin{matrix}{τ}_{UE - TRP} \\ {τ}_{UE - UE} \\ {τ}_{UE - Object}\end{matrix} ] , \qquad ( 1 )$$

where τ_{UE-TRP} is a vector of parameters representative of known channel delays for paths between each UE 110 in the cluster and a TRP, where τ_{UE-UE} is a vector of parameters representative of known channel delays for paths between each UE and each other UE in the cluster and τ_{UE-Object} is a vector of parameters representative of known channel delays for paths between each UE 110 in the cluster and the target 402. The character, n, is representative of noise. The sub-matrices, A₁, A₂, A₃, A₄, A₅, are also known and are related to the topology of the synchronization graph over which the flooding takes place.

The BS 170 may solve the sensing-specific synchronization equation (1) to determine (step 622) the synchronization parameters (estimates for the clock parameters, [w, θ]).

Once an estimate for the clock parameters, [w, θ], has been determined (step 622) by solving the sensing-specific synchronization equation (1), the estimate for the clock parameters, [w, θ], may be transmitted (step 624) to each UE 110 in the sensing cluster. Responsive to receiving the estimates for the clock parameters, a UE 110 may realign its clock to the global time.

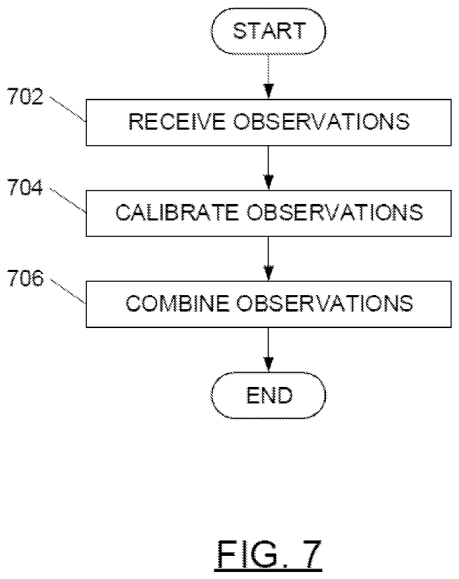

FIG. 7 illustrates example steps in a method of carrying out sensing, as part of a collaborative sensing effort, from the perspective of a BS 170 or a master sensing device (a processing node). The master sensing device receives (step 702) observations obtained at the UEs 110 in the sensing cluster. The master sensing device then coherently combines (step 706) the received observations to, thereby, form an enhanced observation. Coherently combining (step 706) the received observations may involve coherent combining of phase in space domain to achieve range resolution and coherent combining of phase in frequency domain to achieve cross-range resolution.

Alternatively, the estimates for the clock parameters determined in step 622 may be used by the master sensing device to recalibrate (step 704) pre-recorded raw sensing observations. The recalibrated pre-recorded raw sensing observations may then be fused (step 706) into one enhanced observation.

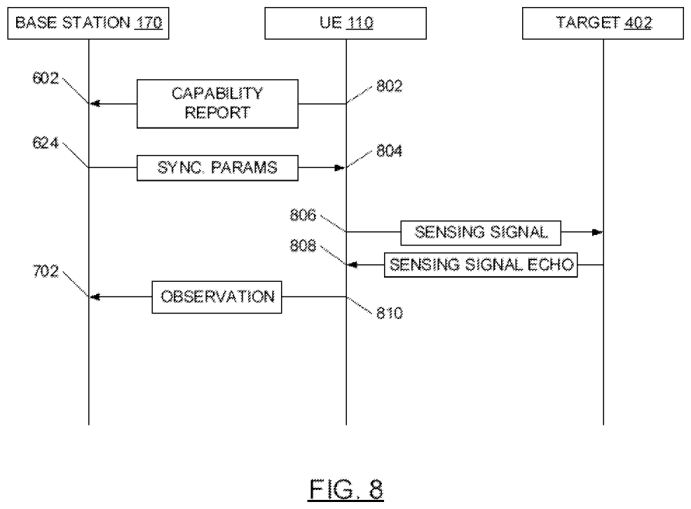

In the environment, there are several manners by which the UEs 110 may obtain observations. One such manner is illustrated in FIG. 8 as a flow diagram. According to the flow diagram of FIG. 8, the UE 110 transmits (step 802) a capability report to the BS 170, where the capability report is received (step 602), as discussed in view of FIG. 6. The BS 170 transmits (step 624) estimate for clock parameters, [w, θ], which estimates are received (step 804) at the UE 110. The UE 110 then transmits (step 806) a sensing signal toward the target 402 (see FIG. 4). Upon receiving (step 808) an echo of the sensing signal, the UE 110 transmits (step 810) an observation through an UL signal. The BS 170 receives (step 702) the observation and may use the observation when forming an enhanced observation.

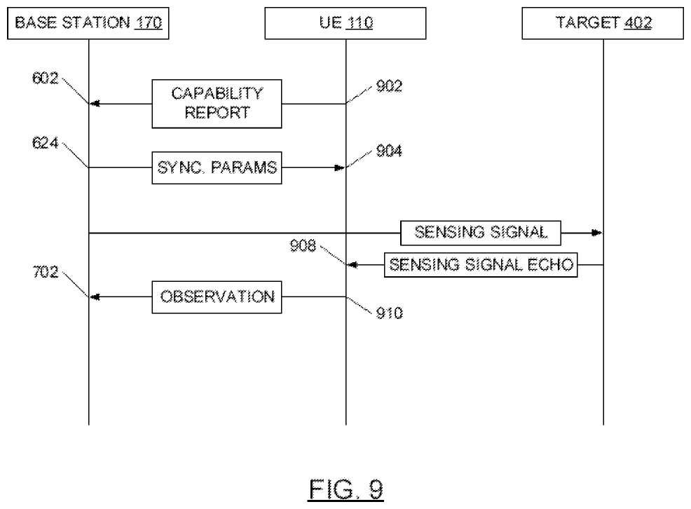

Another such manner is illustrated in FIG. 9 as a flow diagram. According to the flow diagram of FIG. 9, the UE 110 transmits (step 902) a capability report to the BS 170, where the capability report is received (step 602), as discussed in view of FIG. 6. The BS 170 transmits (step 624) estimate for clock parameters, [w, θ], which estimates are received (step 904) at the UE 110. The BS 170 then transmits a sensing signal toward the target 402 (see FIG. 4). Upon receiving (step 908) an echo of the sensing signal, the UE 110 transmits (step 910) an observation through an UL signal. The BS 170 receives (step 702) the observation and may use the observation when forming an enhanced observation.

To this point in the present application, it has been assumed that the respective poses (a location in combination with an orientation) of the UEs 110, within the sensing cluster, are accurately known. In circumstances where the location and orientations of sensing devices are not known at all or are not known with sufficient precision, the coherent combining (step 706) of observations provided by the UEs 110 becomes difficult.

Known cellular networks may provide estimates of the respective locations of UEs 110. However, it is known that cellular network location estimates are only accurate up to a meter or so. Specific aspects of the coherent combining (step 706) of observations related to coherent combining of phase in space domain to achieve cross-range resolution and coherent combining of phase in frequency domain to achieve range resolution may be show to be difficult when only reliant upon position estimates provided by known cellular networks.

Aside from the benefit realized from obtaining accurate information for the respective locations of the UEs 110 within a sensing cluster, further benefit may be realized from the accurate information for the respective orientations of the UEs 110 within the sensing cluster.

The orientation information for a UE 110 is, generally, not provided by a positioning sub-system of known cellular networks. It follows that obtaining sensing-specific positioning information is an aspect of the present application.

To make aspects of the present application inclusive of many scenarios, it is assumed that both clock parameters and sensing device locations are not precisely known. Accordingly, aspects of the present application relate to achieving sensing-specific synchronization and obtaining sensing-specific position information in aid of collaborative sensing.

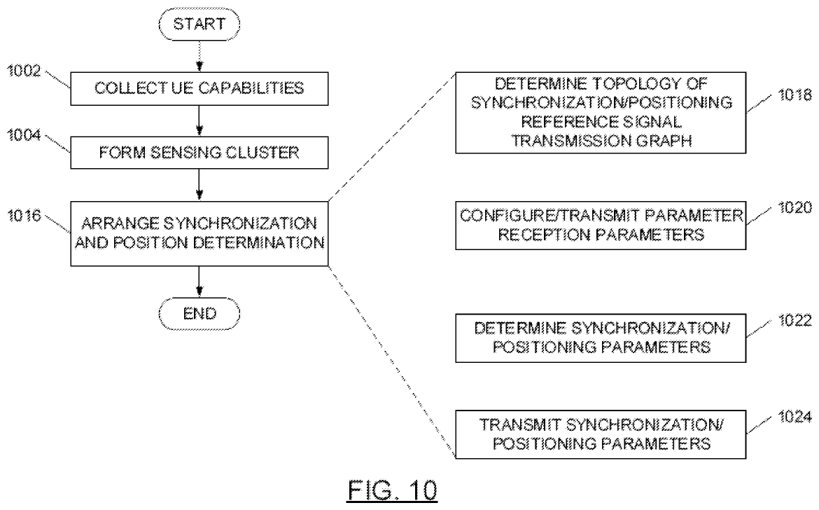

FIG. 10 illustrates example steps in a method, carried out at a base station 170, of configuring collaborative sensing by a plurality of UEs 110. FIG. 10 differs slightly from FIG. 6 in that FIG. 10 relates, in part, to achieving sensing-specific synchronization and obtaining sensing-specific position information in aid of collaborative sensing, whereas FIG. 6 relates to achieving sensing-specific synchronization with positioning assumed to be known.

The BS 170 may begin the task of arranging and configuring the collaborative sensing by collecting (step 1002) capability reports from the UEs 110 in a network.

Subsequent to receiving (step 1002) the capability reports, the BS 170 may take steps to form (step 1004) a sensing cluster. When forming (step 604) the sensing cluster, the BS 170 may take into account the information received in the capability reports.

In the method illustrated in FIG. 10, once a sensing cluster has been formed (step 1004), the BS 170 arranges (step 1016) sensing-specific synchronization and sensing-specific position information in aid of collaborative sensing.

In part, the BS 170 may determine (step 1018) a topology for a so-called synchronization/positioning reference signal transmission graph.

The BS 170 may then, in view of the topology determined in step 1016, configure (step 1020) various parameter reception parameters. The parameter reception parameters may, for example, include a specification of time, frequency and/or waveform for the reception, by the UEs 110, of synchronization/positioning parameters.

As part of arranging (step 1016) synchronization, the BS 170 may determine (step 1022) synchronization/positioning parameters in a manner detailed in the following. The BS 170 may transmit (step 1024), to the UEs 110, the synchronization/positioning parameters.

According to aspects of the present application, arranging (step 1016) sensing-specific synchronization and obtaining sensing-specific position information is performed before a collaborative sensing session may begin.

One or more BSs 170 may be designated as a spatial reference BS 170. The spatial reference BSs 170 transmit positioning reference signals. The positioning reference signals are received by the UEs 110 as a downlink (DL) signal. Responsively, a given UE 110, upon receipt of a positioning reference signal, transmits, to the spatial reference BS 170 in an uplink (UL) signal, a response to the positioning reference signal.

To avoid reference signal transmission overhead, it is proposed herein to merge synchronization reference signals and positioning reference signals into one unifying reference signal. The unifying reference signal may be transmitted at BSs 170 and received at UEs 110 as DL communications. The unifying reference signal may also be transmitted at one UE 110 and received at another UE 110 as sidelink (SL) communications.

The unifying reference signal may be distinguished from the existing reference signals used for synchronization and positioning in cellular networks on the basis of multiple conditions.

According to a first of the multiple conditions, the unifying reference signal may be transmitted over a wider bandwidth than the existing reference signals used for synchronization and positioning in cellular networks.

According to a second of the multiple conditions, the unifying reference signal may be transmitted with higher repetition frequency than the existing reference signals used for synchronization and positioning in cellular networks.

According to a third of the multiple conditions, the unifying reference signal may be transmitted over bands that are muted from other cells so as to inflict less additive interference.

According to a fourth of the multiple conditions, the unifying reference signal may be transmitted with higher transmit power than the existing reference signals used for synchronization and positioning in cellular networks.

According to a fifth of the multiple conditions, the unifying reference signal may be transmitted with a waveform different than the existing reference signal waveform used for synchronization and positioning in cellular networks.

These conditions, taken together or individually, allow for the coherent combining of raw observations (step 706, FIG. 7).

A mathematical representation of the sensing-specific synchronization and positioning problem to be solved to determine (step 1022) synchronization/positioning parameters is presented in equation (2), as follows:

$$[ {A}_{1} \vert {A}_{2} \vert {A}_{3} \vert {A}_{4} ] \cdot [ \begin{matrix}w \\ θ \\ {τ}_{UE - TRP} \\ {τ}_{UE - UE}\end{matrix} ] = n + {A}_{5} {τ}_{UE - Object} , \qquad ( 2 )$$

where τ_{UE-TRP} is a vector of parameters representative of unknown direct-path delays between each UE 110 in the cluster and a TRP, where τ_{UE-UE} is a vector of parameters representative of unknown direct-path delays between each UE 110 and each other UE 110 in the cluster and τ_{UE-Object} is a vector of parameters representative of known direct-path delays between each UE 110 in the cluster and the target 402. The sub-matrices, A₁, A₂, A₃, A₄, A₅, are known and are directly related to the topology of the synchronization/positioning reference signal transmission graph over which the unified reference signals are to be transmitted. The selection of these sub-matrices are to be made by the BS 170 (or the cluster-head) with at least three considerations in mind: the well-posed-ness of the problem; the quality of the estimation; and the reduction of overhead.

The well-posed-ness of problem relates to the selection of these sub-matrices such that the sensing matrix [A₁|A₂|A₃|A₄] is invertible in the particular formulation given by equation (2).

The quality of estimation relates to the selection of sensing devices. The selection may be based on one or more factors, including transmit power, achievable resolution and protocol-stack latencies. Another factor is a degree to which the sensing device has partial knowledge of its orientation and position such that the covariance of the noise, n, in equation (2) remains bounded. If relocation of UEs 110 is possible, selection of UEs 110 may include planning kinematics of the UEs 110.

The reduction of overhead may be understood to lead to a corresponding reduction in latency. The reduction of overhead is related to the determining (step 1018) of the topology for the synchronization/positioning reference signal transmission graph based on the communication/energy capabilities of the sensing devices. The BS 170 configures the time/frequency/power/periodicity resources to be used for transmission of unifying reference signals.

If the problem is to be solved centrally by a processing node (either by the BS 170 or a sensing cluster-head), then the BS 170 is to configure the UE 110 on the synchronization/positioning reference signal transmission graph with the time/frequency/power resources that are required to transmit coefficients of their corresponding equations in equation (2) to that BS 170 (the processing node).

Notably, the processing node that obtains (step 1016) estimates for sensing-specific synchronization and estimates of sensing-specific position information by solving equation (2) is not necessarily the processing node whose responsibility is to use these estimates to coherently combine (step 706) the sensing observations received in step 702 from the UEs 110 in the sensing cluster.

Once the clock bias estimates, the clock skew estimates and the channel delay estimates, [w, θ, τ_{UE-TRP}, τ_{UE-UE}], have been obtained (step 1022) by a given processing node solving the sensing-specific synchronization and positioning equation (2), the given processing node transmits (step 1024) the estimates to a master sensing device. The master sensing device, upon receipt of the estimates, may proceed to calibrate (step 704) raw sensing observations, received (step 702) from the UEs 110, thereby leading to a set of calibrated sensing observations. The master sensing device may then fuse (step 706) the calibrated sensing observations into a single, enhanced observation.

The signaling includes a Sensing-specific Synchronization and Positioning Configuration Declaration (SSPCD) and a Sensing-specific Synchronization & Positioning Parameter Declaration (SSPPD).

The SSPCD includes a specification of time resources and frequency resources to be used for the transmission (step 1024) of the synchronization and position estimates to the master sensing device.

The BS 170 uses the SSPPD to transmit (step 1024) the clock bias estimates, the clock skew estimates and the channel delay estimates, [w, θ, τ_{UE-TRP}, τ_{UE-UE}], to the UEs 110 and/or the cluster-head using the resources specified in the SSPCD.

Sensing-specific synchronization and positioning determination may be shown to improve the quality of resolution enhancement achievable through the collaborative sensing representative of aspects of the present application. Without a tight synchronization and accurate knowledge of location and orientation of the UEs 110 in the sensing cluster, it may be shown to be difficult to achieve the coherent combining (step 706). Another advantage in jointly solving synchronization and positioning problems may be realized as a reduction in the overhead caused by transmission of separate reference signals for solving the synchronization and positioning problems separately.

The aspects of the present application presented to this point aim to improve sensing resolution through coherently combining (step 706) raw sensing observations collected by multiple, scattered, candidate UEs 110. In an alternative aspect of the present application, collaborative sensing can be seen as a method to reduce the sensing overhead and/or gain sensing precision.

On the one hand, “sensing precision gain” may be understood as an ability of a system to make a more accurate prediction about respective locations of objects in a scene. On the other hand, “sensing resolution gain” may be understood as an ability of a system to distinguish between two closely-spaced details in a scene. That is, sensing precision gain is different from sensing resolution gain. Sensing resolution gain may be understood as being more difficult to achieve than sensing precision gain.

In aspects of the present application related to collaborative sensing, precision gain is achievable when multiple inter-related problems are to be dealt with concurrently. These multiple, inter-related problems have classically been dealt with separately. These multiple, inter-related problems are synchronization, positioning and sensing (SPS). The joint approach to solving these three inter-related problems has an important underpinning that is rooted in the relationship between them.

Synchronization and positioning are joint problems known from communications. Positioning and sensing are joint problems known from robotics. It follows that sensing and synchronization are joint problems. From these deductions, it is trivial to see that all three sub-problems are somewhat entangled, hence, better be solved jointly. In this new framework, collaborative sensing is a fundamental revamp of what sensing embodies.

Whereas the classic form of sensing is related to gaining cognition about the environment state only, sensing may now be redefined as gaining cognition about time, environment state and users' states. Note that this does not mean that positioning is always impossible without simultaneously solving for sensing and synchronization. Indeed, in many circumstances, a map may be provided, as extracted from a further subsystem, to localize users in a cellular positioning subsystem. The further subsystem that provides the map, may, for example, be a satellite imaging subsystem. Similarly, in other circumstances, synchronization may have been achieved and provided by another subsystem (say, the timing provided by the Global Positioning System). The provided synchronization may be used for sensing.

Aspects of the present application relate to jointly solving the three inter-related problems. It may be shown that, by using the same subsystem to solve for positioning, synchronization and sensing, there is gain to be realized by solving these three problems simultaneously rather than serially. This gain may be realized in the form of a saving on network resources such as bandwidth, time and/or power. Synchronization and positioning each, individually, typically depend on the transmission of independent sets of reference signals between TRPs and UEs. It may be shown that there is gain in preserving network communication resources through the transmission of only one set of reference signals between TRPs and UEs and solving the positioning, synchronization and sensing problems jointly.

According to aspects of the present application, the type of interconnection between the UEs 110 allows the UEs 110 to be able to determine time, environment and UE states. The UEs 110 have been discussed hereinbefore as being assigned the task of transmitting (steps 810, 910) observations of returned echoes of sensing signals to the BS 170 through an UL signal. Responsive to receiving (step 702) the observations, the BS 170 then coherently combines (step 706) the observations into an enhanced observation. In contrast to such a centralized approach, collaborative sensing may be arranged to allow sensing and communications links between UEs 110, thereby allowing for a de-centralized approach.

In this aspect of the present application, the UE 110 obtains observations on the basis of the sensing signals that the UE 110 transmitted in the environment (e.g., towards the target 402, FIG. 4). Additionally, the UE 110 obtains observations on the basis of the sensing signals that other UEs 110 have transmitted.

That is, a given UE 110 may obtain observations for a sensing signal that has been transmitted on a line-of-sight sidelink (SL) communication at one or more other UEs 110. Furthermore, the given UE may also obtain observations on a sensing signal that has been transmitted by the BS 170 on a DL communication.

In contrast to the solution to the three sub-problems depending on transmission of reference signals with similar nature and different name, the joint solution of the SPS problem involves transmission of a single type of reference signal. The single type of reference signal is referenced, herein, as a “unifying” RS (U-RS). The U-RS is transmitted across the network (i.e., between UEs, TRPs and the environment).

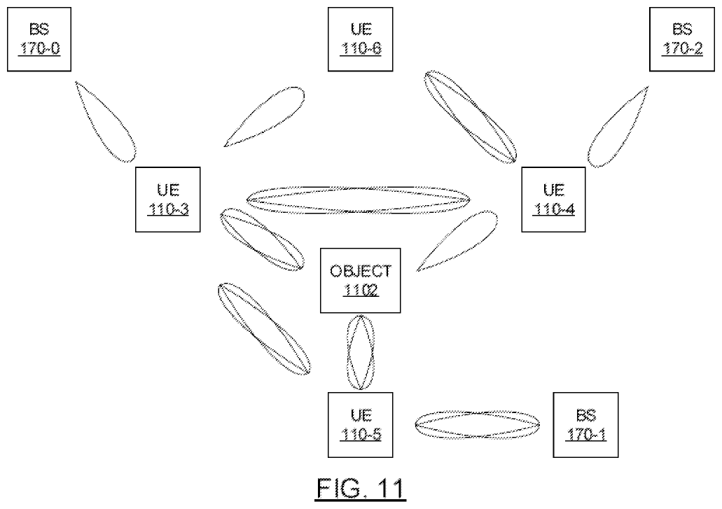

FIG. 11 illustrates an example network scenario wherein three BSs 170-0, 170-1, 170-2 (collectively or individually 170) and four UEs 110-3, 110-4, 110-5, 110-6 may collaborate in sensing one or more objects such as an object 1102.

The gain from collaborative sensing may be considered to be evident from FIG. 11. In Euclidean space, to localize a UE 110 unambiguously, UL/DL sensing interconnections to multiple BSs 170 are used. However, due to a SL sensing interconnection between UEs 110, it is sufficient for each UE 110 to be connected to one BS 170 through UL/DL sensing interconnection. Moreover, the SL sensing interconnection between UEs 110 enables the BS 170 to learn about the proximity of UEs 110. The proximity of UEs 110 may be considered to be an important source of information, especially when minimizing the collection of redundant observations from the environment.

In FIG. 11, both unidirectional sensing links and bidirectional sensing links are illustrated between the BSs 170, the UEs 110 and the object 1102. A unidirectional sensing link is illustrated from the BS 170-0 to the UE 110-3. A unidirectional sensing link is illustrated from the UE 110-3 to the UE 110-6. A unidirectional sensing link is illustrated from the BS 170-2 to the UE 110-4. A bidirectional sensing link is illustrated between the UE 110-4 and the UE 110-6. A unidirectional sensing link is illustrated from the object 1102 to the UE 110-3. A bidirectional sensing link is illustrated between the UE 110-3 and the UE 110-4. A bidirectional sensing link is illustrated between the UE 110-3 and the object 1102. A bidirectional sensing link is illustrated between the UE 110-3 and the UE 110-5. A bidirectional sensing link is illustrated between the UE 110-5 and the object 1102. A bidirectional sensing link is illustrated between the UE 110-5 and the BS 170-1.

As discussed hereinbefore, a sensing cluster may be formed on the basis of the capability reports that are collected in an initiation step. Notably, forming the sensing cluster in steps 604 (FIG. 6) and 1004 (FIG. 10) entailed selecting only UEs 110. In contrast, in this context of FIG. 11, the forming of a sensing cluster may be expanded to include the BSs 170. Such an expansion of the definition of the sensing cluster may be shown to allow spatial and temporal reference information to be transferred to the UEs 110.

Notably, the sensing cluster definition may be restricted to only specify the identity of the UEs 110 that are to be involved in the collaborative sensing. That is, the sensing cluster definition need not include information on the extent to which the UEs 110 are interconnected with each other. Indeed, information on the extent to which the UEs 110 are interconnected with each other is included in a sensing graph. The sensing graph may be defined as a finite, cyclic (or acyclic), directed, labelled graph representing the sensing links between UEs 110, BSs 170 and objects 1102 in the environment.

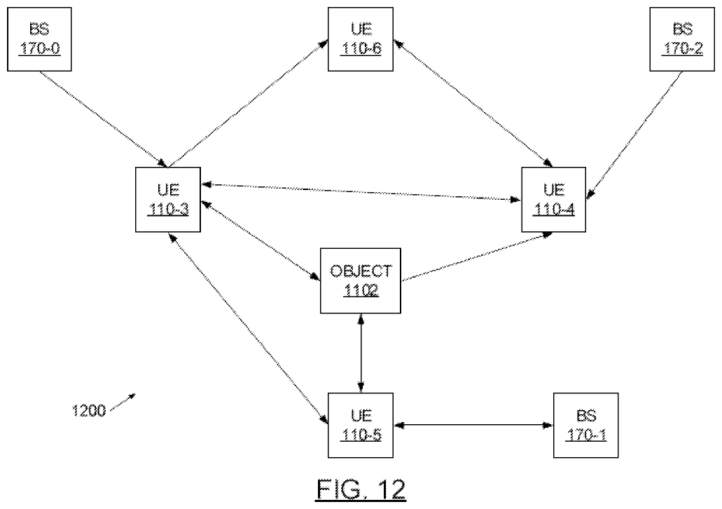

FIG. 12 illustrates an example sensing graph 1200 for the sensing scenario in FIG. 11. The specification of the sensing graph 1200 may be based on the capability reports and proximal reports collected from the UEs 110. This specification can either be made by the BS 170 or a cluster-head UE 110. Designation of a particular UE 110 as the cluster-head may be decided upon based on the particular UE 110 having a favorable geometry with respect to all UEs 110 or the particular UE 110 being more capable in terms of processing and/or communications. By deciding upon a particular UE 110 in this manner, the communications of the ensuing steps is facilitated. Once the sensing graph 1200 has been established, a configuration step ensues, wherein the UEs 110 within the sensing cluster are informed of their role in the sensing task and their resources using the specific signaling.

Using the sensing graph 1200 and given the sensing configuration parameters, the UEs 110 within the sensing cluster start collecting sensing observations by transmitting the U-RS over the sensing graph 1200. The transmission of the U-RS by a given UE 110 may be based on an allocation schedule provided to the given UE 110 in the configuration step. A sensing session may be defined as a period during which all UEs 110 within a sensing cluster complete the sensing tasks that are assigned to them. Upon the conclusion of a sensing session, the processing ensues. The processing may involve jointly estimating the clock parameters and positional parameters (step 1022, FIG. 10). Processing of sensing data may be carried out in a distributed manner, a semi-distributed manner or a centralized manner. In a case wherein processing is carried out in a centralized manner, all UEs 110 in the sensing cluster transmit their sensing observations to a central device (not shown) so that the central device can process the sensing observations jointly. In a case wherein processing is carried out in a distributed manner, some of the UEs 110 within the sensing cluster carry out the processing by exchanging (e.g., using message passing algorithms) intermediary beliefs with each other until a convergent solution emerges. In a case wherein the processing is carried out in a semi-distributed manner, a few candidate UEs 110 having higher processing capabilities carry out the processing in a joint fashion. Regardless of the manner of the processing, the UEs 110 transmit their sensing observations to one or more UEs 110 (for the semi-distributed manner of processing) or the central device (for the centralized manner of processing) ahead of time and before the processing starts.

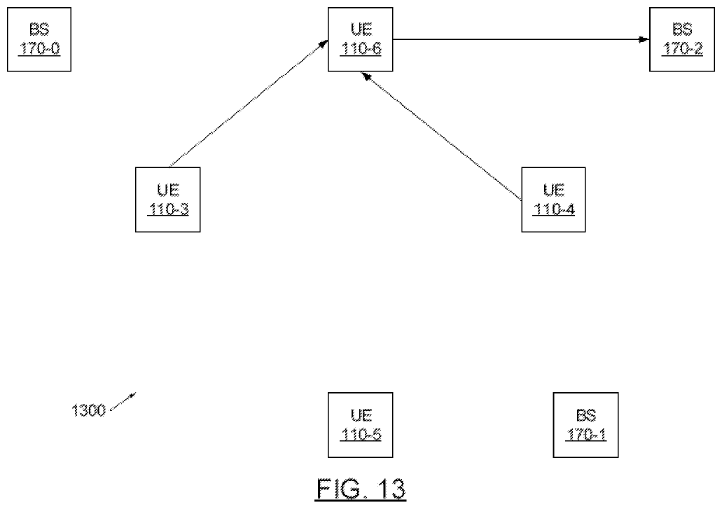

This transmission benefits from the determination of a transmission graph. A vertex on a transmission graph represents a UE 110 that is either the receiver of sensing observations or a transmitter of sensing observations. An edge between two vertices denotes that the sensing observations are transmitted from one UE 110 to another UE 110 for processing. A receiving vertex is not necessarily the destination vertex but the receiving vertex can be a relay toward another UE 110. In general, the transmission graph is a finite, acyclic, directed graph that represents the flow of raw sensing observations between sensing devices (UEs 110 and/or BSs 170). FIG. 13 illustrates an example transmission graph 1300 for the sensing scenario in FIG. 11.

In the sensing graph 1200 of FIG. 12, the UE 110-6, which may be understood to have reduced sensing capability relative to the other UEs 110, does not participate in the sensing of the object 1102. However, in the transmission graph 1300 of FIG. 13, the UE 110-6 acts as a relay to transfer sensing observations from the UE 110-3 and the UE 110-4 to the BS 170-2. Note that processing is not necessarily carried out in a centralized manner at the BS 170-2; as explained hereinafter, the BS 170-2 may be only one processor among a plurality of processors in a processing cluster.

When all sensing observations have arrived at their designated destinations, as specified by the transmission graph 1300, the processing may commence. The processing may be shown to benefit from the determination of yet another graph, namely a processing graph. In short, the processing graph dictates which devices form a processing cluster and how devices within that processing cluster exchange their intermediary beliefs with each other. Depending on whether the processing is carried out in a centralized manner, a semi-distributed manner or a fully distributed manner, the processing graph will vary. For instance, when the processing is to be carried out in a centralized manner (i.e., at a single BS 170), then the processing graph is a null graph. On the other hand, when the processing is to be carried out in a distributed manner or in a semi-distributed manner, the processing graph will be a finite, acyclic (or cyclic), directed graph that reflects the flow of transformed sensing observations (e.g., partial inference outcomes) among processors with the processing cluster.

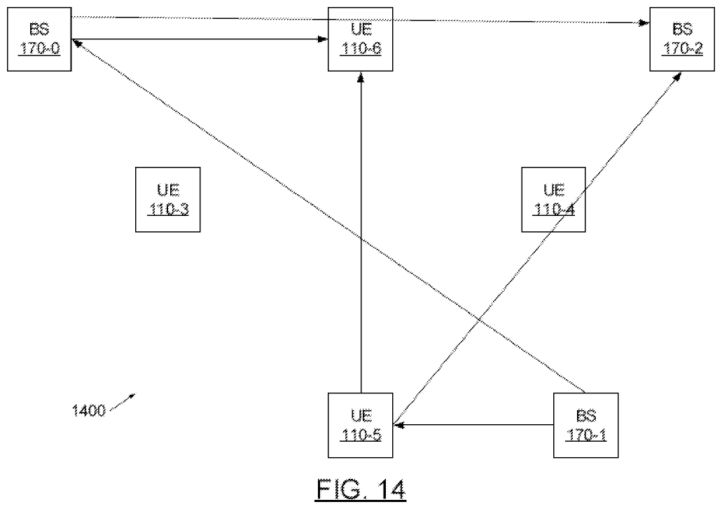

FIG. 14 illustrates an example processing graph 1400 for the sensing scenario in FIG. 11. Note that the UE 110-5, the BS 170-0 and the BS 170-1 are not participants in transmission graph 1300. However, in accordance with the processing graph 1400 of FIG. 14, the BS 170-1 transmits partial inference outcomes to the UE 110-5 and the BS 170-0. Similarly, the UE 110-5 transmits partial inference outcomes to the UE 110-6 and the BS 170-2. Additionally, the BS 170-0 transmits partial inference outcomes to the UE 110-6 and the BS 170-2.

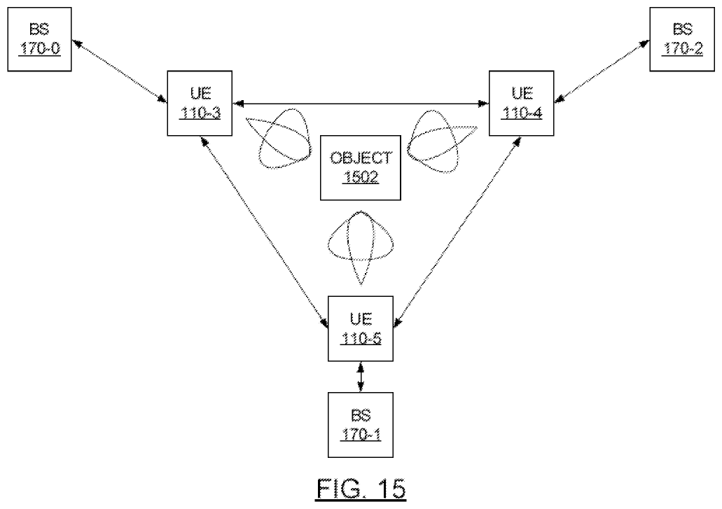

FIG. 15 illustrates an example network scenario, as an alternative to the example network scenario of FIG. 11, wherein three BSs 170-0, 170-1, 170-2, and three UEs 110-3, 110-4, 110-5 collaborate to solve the SPS problem to sense an object 1502.

Joint formulation of the so-called SPS problem may be represented as matrix equation (3) as follows:

$$[ {A}_{1} \vert {A}_{2} \vert {A}_{3} \vert {A}_{4} \vert {A}_{5} ] \cdot [ \begin{matrix}w \\ θ \\ {τ}_{UE - TRP} \\ {τ}_{UE - UE} \\ {τ}_{UE - Object}\end{matrix} ] = n , \qquad ( 3 )$$

where the clock parameters, w=[w₃, w₄, w₅] and θ=[θ₃, θ₄, θ₅], represent unknown clock skew parameters and clock bias parameters for the UE 110-3, the UE 110-4 and the UE 110-5. The unknown vector τ_{UE-TRP}=[τ_{0,3}, τ_{2,4}, τ_{1,5}] denotes the distance between BSs 170 and UEs 110. The unknown vector τ_{UE-UE}=[τ_{3,4}, τ_{3,5}, τ_{4,5}] denotes the distance between individual UEs 110, as dictated by a sensing graph. Finally, the unknown vector τ_{UE-Object}=[ [symbol] , [symbol] , [symbol] ] signifies the distance from each UE 110 to the object 1502.

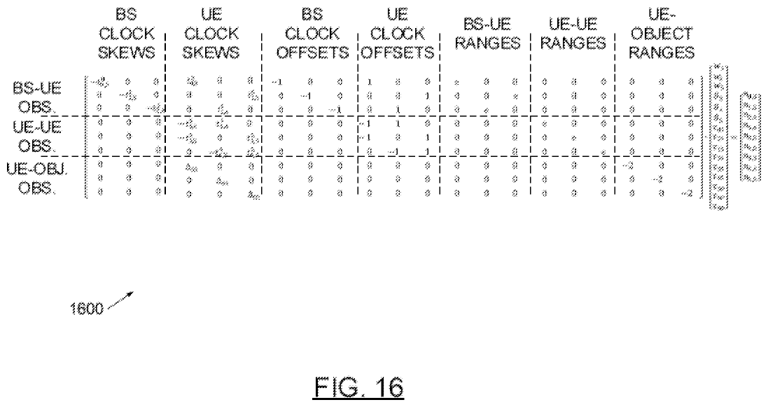

FIG. 16 illustrates an example expansion 1600 of equation (3) to illustrate individual matrix elements.

The signaling involved in the specification and distribution of the transmission graph and the processing graph include: Transmitter Selection Declaration (TSG) signaling; TSG Resource Set signaling; and Exchanged Sensing Resource Set signaling.

The TSG signaling includes an indication regarding whether a UE 110 is configured to keep the sensing information (observations) or relay the observations to another UE 110. If the UE 110 is configured to relay the observation, the TSG signaling also includes an identification of the UE 110 to which the UE 110 is configured to send the observations.

The TSG Resource Set signaling includes indications of a time resource set and a frequency resource set to which the UE 110 if to tune so as to receive the TSG signaling.

The Exchanged Sensing Resource Set signaling is to be used in situations wherein sensing is controlled centrally. The Exchanged Sensing Resource Set signaling includes indications of time resources, frequency resources, waveform resources, power resources and/or bandwidth resources over which the UE 110 is configured to send the observations to another UE 110 or network entity.

In the semi-distributed and distributed setting, the selection of the processing cluster depends on processing and energy capability of the elements of the processing cluster. As such, the BS 170 (or cluster-head) may collect processing capabilities from the UEs 110 at an initial step to inform the selection of the processing cluster. The PECR mentioned in the context of collecting (step 602, FIG. 6) capability reports may be a suitable manner in which to receive processing capabilities from the UEs 110.

Upon reaching a decision on the inclusion/exclusion of particular UEs 110 in the processing cluster, the BS 170 transmits, to the UEs 110 that have been included in the processing cluster, a notification regarding their processing role. The notification may take the form of: a Processor Selection Declaration (PSD); a PSD Resource Assignment; and an Exchanged Inferential Information Resource Set.

The BS 170 may transmit, to each UE 110, the PSD to indicate whether the UE 110 has been included in the processing cluster or excluded from the processing cluster. The PSD Resource Assignment may be employed by the BS 170 to notify each UE 110 about the time and frequency resources over which to expect to receive the PSD. The Exchanged Inferential Information Resource Set may be employed by the BS 170 to notify each UE 110 about the resources over which to transmit the partial inferential outcomes to another node in the processing cluster. The resources may, for example, include time resources, frequency resources, waveform resources, power resources and bandwidth resources.

It may be considered that the collaborative sensing represented by aspects of the present application scales well to the size of the problem in wireless environments with numerous objects to sense and numerous parameters (variables) to estimate. It may further be considered that the collaborative sensing represented by aspects of the present application conveniently allows for sensing of the deepest points in a given network. It may still further be considered that the collaborative sensing represented by aspects of the present application conveniently improves the accuracy of sensing by improving the resolution through distributed coherent combining. It may even further be considered that the collaborative sensing represented by aspects of the present application is conveniently robust to failure, since “eyes” (sensing devices) and “muscles” (processing) may be distributed across a given network. It may even further be considered that the collaborative sensing represented by aspects of the present application conveniently preserves privacy, since processing the sensing data may be carried out distributed manner.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
receiving, by a user equipment (UE), timing information for a sensing signal;
receiving, by the UE and based on the timing information, a reflection of the sensing signal as part of carrying out an environment sensing operation; and
transmitting, to a processing node, an indication of the received reflection.

2. The method of claim 1, further comprising transmitting, by the UE, a capability message to the processing node.

3. The method of claim 1, further comprising receiving, by the UE, control signaling indicating that the UE is part of a cluster of sensing devices.

4. The method of claim 1, further comprising:
receiving an instruction to perform a sensing-specific synchronization operation; and
performing a synchronization operation with a specific sensing device among the plurality of sensing devices.

5. The method of claim 1, further comprising transmitting, by the UE, the sensing signal for carrying out the environment sensing operation.

6. The method of claim 1, wherein the sensing signal is a radio frequency waveform for performing a sensing operation.

7. A method comprising:
obtaining, by a processing node, information about transmission resources for a plurality of observations associated with a respective plurality of user equipments (UEs);
receiving, by the processing node, the plurality of observations from the respective plurality of UEs according to the obtained information about the transmission resources; and
processing the received plurality of observations for generating an enhanced observation.

8. The method of claim 7, wherein obtaining the information about the transmission resources comprises receiving control signaling from a base station, the control signaling for indicating the transmission resources.

9. An apparatus comprising at least one processor configured to execute instructions to cause the apparatus to perform operations including:
receiving, by the apparatus, timing information for a sensing signal;
receiving, by the apparatus and based on the timing information, a reflection of the sensing signal as part of carrying out an environment sensing operation; and
transmitting, to a processing node, an indication of the received reflection.

10. The apparatus of claim 9, wherein the operations further include:
transmitting, by the apparatus, a capability message to the processing node.

11. The apparatus of claim 9, wherein the operations further include:
receiving, by the apparatus, control signaling indicating that the apparatus is part of a cluster of sensing devices.

12. The apparatus of claim 9, wherein the operations further include:
receiving an instruction to perform a sensing-specific synchronization operation; and
performing a synchronization operation with a specific sensing device among the plurality of sensing devices.

13. The apparatus of claim 9, wherein the operations further include:
transmitting, by the apparatus, the sensing signal for carrying out the environment sensing operation.

14. The apparatus of claim 9, wherein the sensing signal is a radio frequency waveform for performing a sensing operation.

15. A non-transitory computer-readable medium storing programming, the programming including instructions to:
receive timing information for a sensing signal;
receive, based on the timing information, a reflection of the sensing signal as part of carrying out an environment sensing operation; and
transmit an indication of the received reflection.

16. The non-transitory computer readable medium of claim 15, wherein the programming further includes instructions to:
transmit a capability message to the processing node.

17. The non-transitory computer readable medium of claim 15, wherein the programming further includes instructions to:
receive control signaling indicating that an apparatus for executing the instructions is part of a cluster of sensing devices.

18. The non-transitory computer readable medium of claim 15, wherein the programming further includes instructions to:
receive an instruction to perform a sensing-specific synchronization operation; and
perform a synchronization operation with a specific sensing device among the plurality of sensing devices.

19. The non-transitory computer readable medium of claim 15, wherein the programming further includes instructions to:
transmit the sensing signal for carrying out the environment sensing operation.

20. The non-transitory computer readable medium of claim 15, wherein the sensing signal is a radio frequency waveform for performing a sensing operation.
